(19) United States
(12) Patent Application Publication
(10) Pub. No.: US 2007/0236619 A1
(43) Pub. Date: Oct. 11, 2007

(54) Image display device

(75) Inventor: Chien-Chung Kuo, Feng Yuan City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/599,476

(22) Filed: Nov. 15, 2006

(30) Foreign Application Priority Data
Apr. 21, 2006 (TW) 095114235

(51) Int. Cl. G02F 1/1335

(52) U.S. Cl. 349/15

(57) ABSTRACT

An image display device capable of being switched between a 2D and a 3D display modes includes a liquid crystal display panel and a self-luminous parallax optic. The liquid crystal display panel has a plurality of first and second picture elements that are alternatively arranged for respectively representing left-eye and right-eye image data. The self-luminous parallax optic has a first mode of forming alternate bright and dark regions and a second mode of forming an entire bright region thereon, where the alternate bright and dark regions are staggered relative to the first and second picture elements to create stereoscopy effect.

### BACKGROUND OF THE INVENTION

(a) Field of the Invention

The invention relates to an image display device, and particularly to an image display device capable of being switched between a two-dimensional (2D) display mode and a three-dimensional (3D) display mode.

(b) Description of the Related Art

FIG. 1 shows a schematic diagram illustrating a conventional image display device 100 capable of being switched between a 2D and a 3D display modes. Referring to FIG. 1, the image display device 100 includes a liquid crystal display (LCD) panel 110, a liquid crystal shutter 120, and a backlight module 130. The LCD panel 110 includes substrates 111 and 113 and a liquid crystal layer 112 interposed between them. The liquid crystal shutter 120, which is used as a parallax optic to block one eye from seeing images prepared for the other eye, also includes substrates 121 and 123 and a liquid crystal layer 122 interposed between them.

When the liquid crystal shutter 120 is turned off, light emitted from the backlight module 130 may pass through all areas of the liquid crystal shutter 120 to result in a 2D display mode. In contrast, when the liquid crystal shutter 120 is turned on, applied voltages may alter the orientation of liquid crystal molecules in the shutter 120 to partition the shutter areas into multiple spaced opaque and transparent regions (not shown). The opaque regions and transparent regions are alternately arranged and staggered relative to the picture elements of the LCD panel 110 so that, when light emitted from the backlight module 130 passes through the liquid crystal shutter 120 and the LCD panel 110, the left and right eye images are directed solely at the appropriate eye to result in a 3D display mode.

However, in the conventional design, the LCD panel 110, liquid crystal shutter 120, and backlight module 130 are all essential to achieve the 2D and 3D display modes. Thus, none of the components of the image display device 100 can be omitted to further reduce its weight, fabrication cost, and overall thickness.

### BRIEF SUMMARY OF THE INVENTION

An object of the invention is to provide a comparatively thin and light image display device capable of being switched between a 2D and a 3D display modes.

According to the invention, an image display device capable of being switched between a 2D and a 3D display modes includes a liquid crystal display panel and a self-luminous parallax optic. The liquid crystal display panel has a plurality of first and second picture elements that are alternatively arranged for representing left-eye and right-eye image data, respectively. The self-luminous parallax optic has a first mode of forming alternate bright and dark regions and a second mode of forming an entire bright region thereon, where the alternate bright and dark regions are staggered relative to the first and second picture elements to create stereoscopy effect. The self-luminous parallax optic may be an organic light-emitting diode (OLED) display, a plasma display panel (PDP), a field emission display (FED), or a vacuum fluorescent display (VFD).

Through the design of the invention, since the self-luminous parallax optic can function as both a light source for providing illumination and a parallax optic for creating stereoscopy effect, such single component may replace both the backlight module and the liquid crystal shutter in the conventional design. Thus, this may significantly reduce the weight, fabrication cost, and overall thickness of an image display device capable of being switched between a 2D and a 3D display modes.

### BRIEF DESCRIPTION OF THE DRAWINGS

FIG. 1 shows a schematic diagram illustrating a conventional image display device capable of being switched between a 2D and a 3D display modes.

FIG. 2 shows a schematic diagram illustrating an image display device and its 3D display mode according to an embodiment of the invention.

FIG. 3 shows a schematic diagram illustrating an image display device and its 2D display mode according to an embodiment of the invention.

FIG. 4 shows a schematic diagram illustrating another embodiment of the invention.

FIG. 5 shows a schematic diagram illustrating another embodiment of the invention.

FIG. 6A shows a schematic diagram illustrating the positions of first and second picture elements in relation to the alternate bright and dark regions according to an embodiment of the invention.

FIG. 6B shows patterns of picture elements respectively seen by the right and left eyes according to the arrangement shown in FIG. 6A.

FIG. 7A shows a schematic diagram illustrating the positions of first and second picture elements in relation to the alternate bright and dark regions according to another embodiment of the invention.

FIG. 7B shows two complementary delta RGB sub-pixel arrangements respectively seen by the right and left eyes of an observer according to the arrangement shown in FIG. 7A.

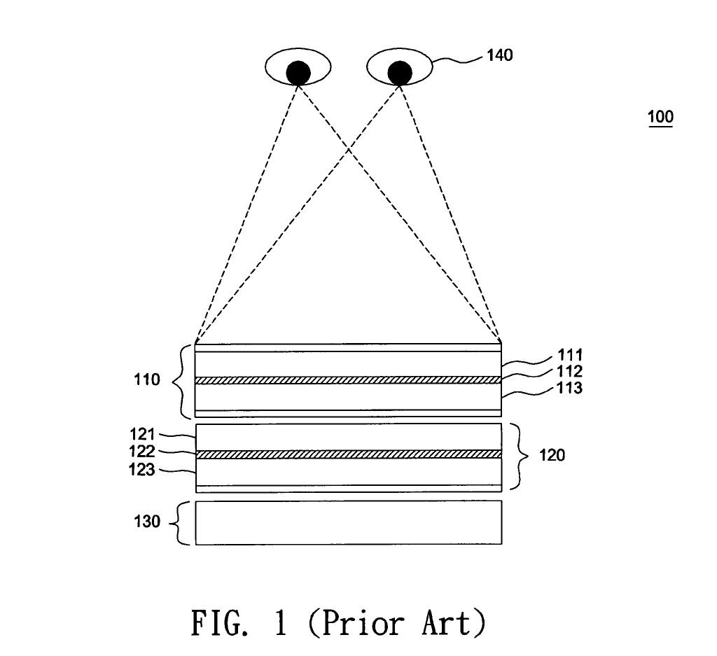

### DETAILED DESCRIPTION OF THE INVENTION

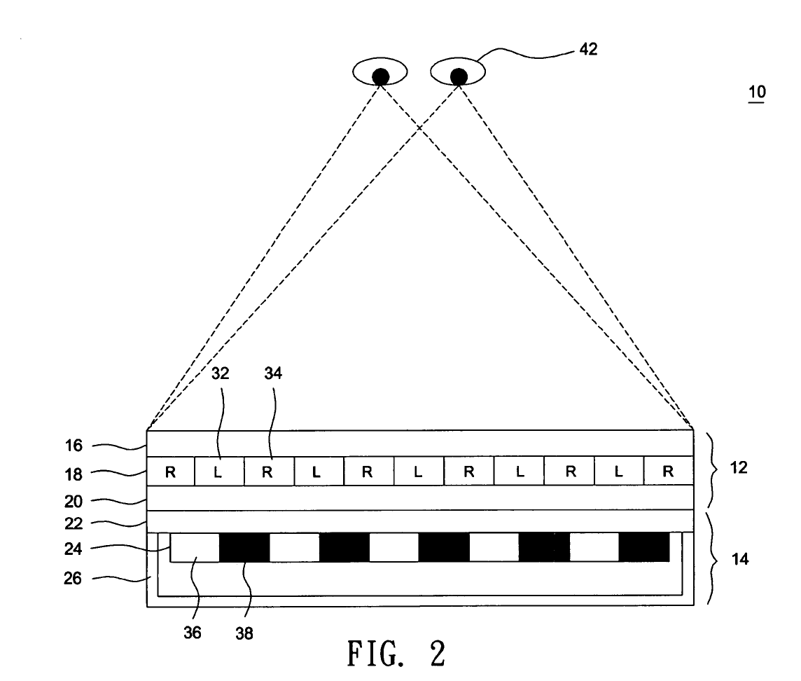

FIG. 2 shows a schematic diagram illustrating an image display device 10 according to an embodiment of the invention. Referring to FIG. 2, the image display device 10 includes an LCD panel 12 and a self-luminous parallax optic 14. The LCD panel 12 includes transparent substrates 16 and 20 and a liquid crystal layer 18 interposed between them. Also, the LCD panel 12 has multiple first picture elements 32 and second picture elements 34 that are alternately arranged for respectively representing left-eye and right-eye image data.

In this embodiment, the self-luminous parallax optic 14 is an organic light-emitting diode (OLED) display that includes a transparent substrate 22, an organic light-emitting diode structure 24, and a encapsulating substrate 26. The organic light-emitting diode structure 24 is deposited on the transparent substrate 22 and encapsulated thereon by the encapsulating substrate 26. Further, the self-luminous parallax optic 14 is attached on one side of the LCD panel 12 through the combination of the transparent substrate 22 and the transparent substrate 20.

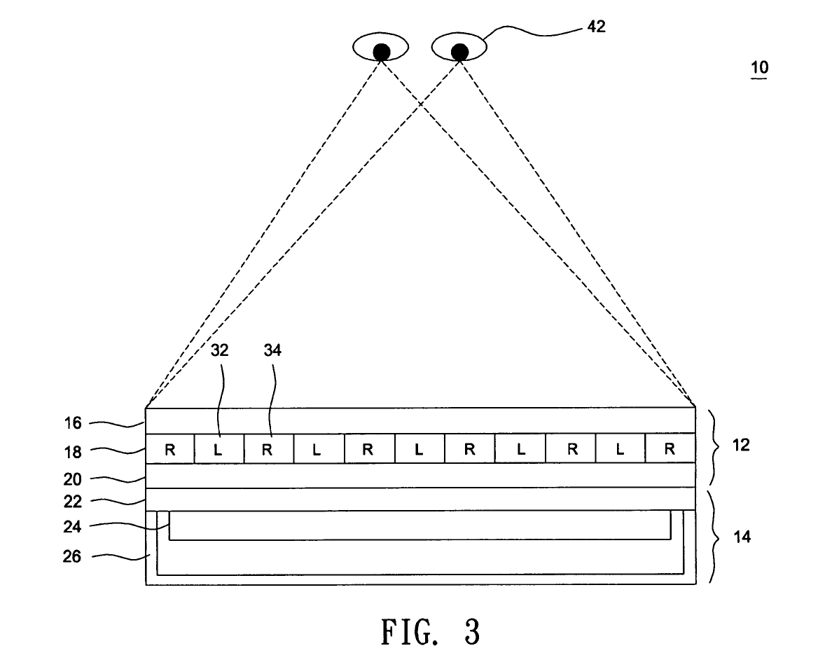

According to the invention, the self-luminous parallax optic 14 emits light in two ways. The first mode is to activate the organic light-emitting diode structure 24 in selected regions so as to form alternate bright regions 36 and dark regions 38 thereon, as shown in FIG. 2. The alternate bright regions 36 and dark regions 38 are staggered relative to the first picture elements 32 and second picture elements 34 to create stereoscopic effect. In contrast, the second mode is to form an entire bright region of the organic light emitting diode structure 24 when a voltage is applied across it, as shown in FIG. 3. Thus, in case the alternate bright regions 36 and dark regions 38 are formed, they may keep the left eye images data represented by the first picture elements 32 directed solely at the left eye and keep the right eye images data represented by the second picture elements 34 directed solely at the right eye of an observer 42 to result in a 3D display mode. In contrast, in case an entire bright region is formed, either the left eye or the right eye of an observer 42 may observe the entire first and second picture elements without discrimination to result in a 2D display mode.

Through the design of the invention, since the self-luminous parallax optic 14 can function as both a light source for providing illumination and a parallax optic for creating stereoscopy effect, such single component may replace both the backlight module and the liquid crystal shutter in the conventional design. Thus, this may significantly reduce the weight, fabrication cost, and overall thickness of an image display device capable of being switched between a 2D and a 3D display modes. Further, the self-luminous parallax optic 14 includes, but is not limited to, an OLED display, other self-luminous devices such as a plasma display panel (PDP), field emission display (FED), and vacuum fluorescent display (VFD) may also be used. In that case, the light-emitting structure of the self-luminous device also has a first mode of forming alternate bright and dark regions and a second mode of forming an entire bright region thereon. Moreover, the substrate positioned at one side of the LCD panel 12 with a predetermined gap within which the light-emitting structure is provided is not limited to the encapsulating substrate 26, and its shape and position are modified according to the selection of the different kinds of self-luminous devices.

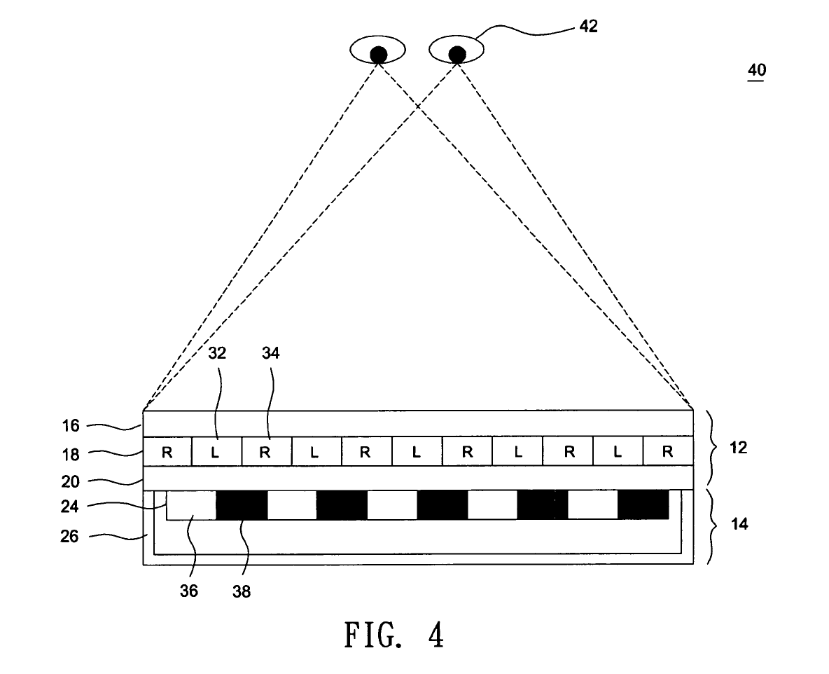

FIG. 4 shows a schematic diagram illustrating another embodiment of the invention. Referring to FIG. 4, in the image display device 40, the LCD panel 12 and the self-luminous parallax optic 14 share a common transparent substrate 20. The organic light-emitting diode structure 24 is deposited on the transparent substrate 20 and encapsulated thereon by the encapsulating substrate 26. Thus, another substrate 22 (shown in FIG. 2) can be omitted to further reduce the weight and overall thickness.

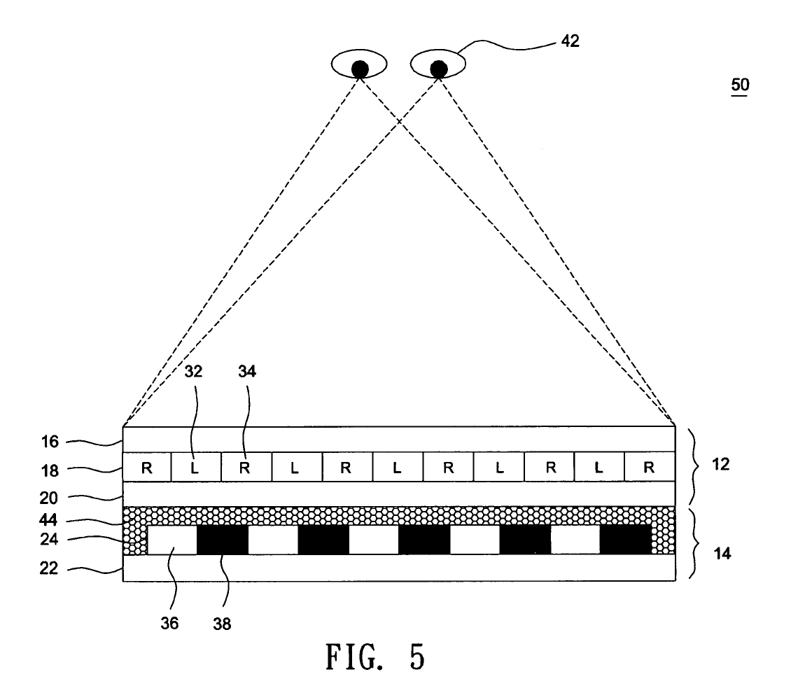

FIG. 5 shows a schematic diagram illustrating another embodiment of the invention. Referring to FIG. 5, in the image display device 50, the organic light-emitting diode structure 24 is deposited on a transparent substrate 22, and a passivation layer 44 is additionally provided between the organic light-emitting diode structure 24 and the transparent substrate 20. The passivation layer 44, which is made of transparent insulation materials, covers all the alternate bright regions 36 and dark regions 38 under the first mode. Hence, the thickness of the passivation layer 44 can be adjusted to vary the distance between the bright and dark regions and the picture elements so as to obtain an optimal stereoscopic effect.

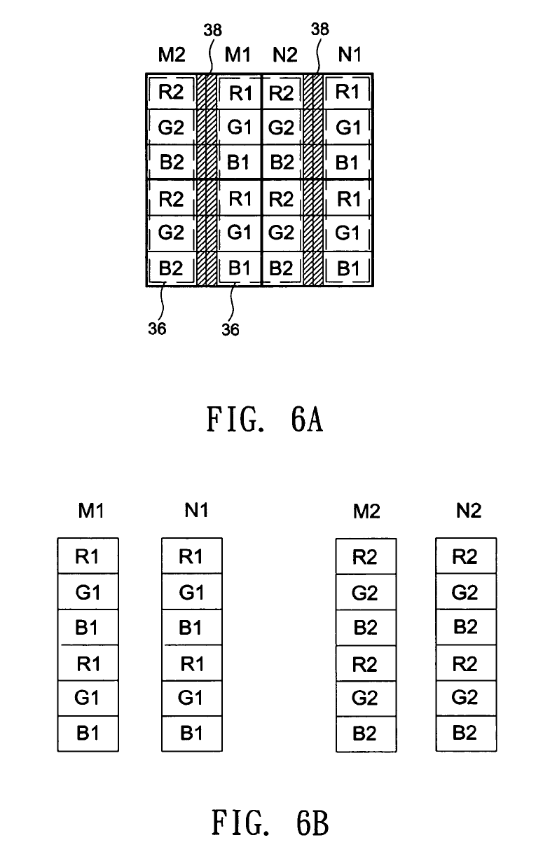

According to the invention, the arrangement of the first and second picture elements in relation to the alternate bright and dark regions is not limited. For example, as shown in FIG. 6A, first picture elements 32 (including sub-pixels R1, G1, and B1) are arranged into multiple first rows M1 and N1, and second picture elements 34 (including sub-pixels R2, G2, and B2) are arranged into multiple second rows M2 and N2, with each first row and each second row being alternate with each other. Further, the bright regions 36 and dark regions 38 are formed on the self-luminous parallax optic 14 as multiple alternate bright and dark stripes, and each stripe is positioned corresponding to two adjacent rows of picture elements; in other words, they are staggered relative to the rows of picture elements. Hence, through a proper alignment of the dark stripes in relation to the rows of picture elements, the right eye of an observer observes only the first rows M1 and N1 while the left eye observes only the second rows M2 and N2, as shown in FIG. 6B.

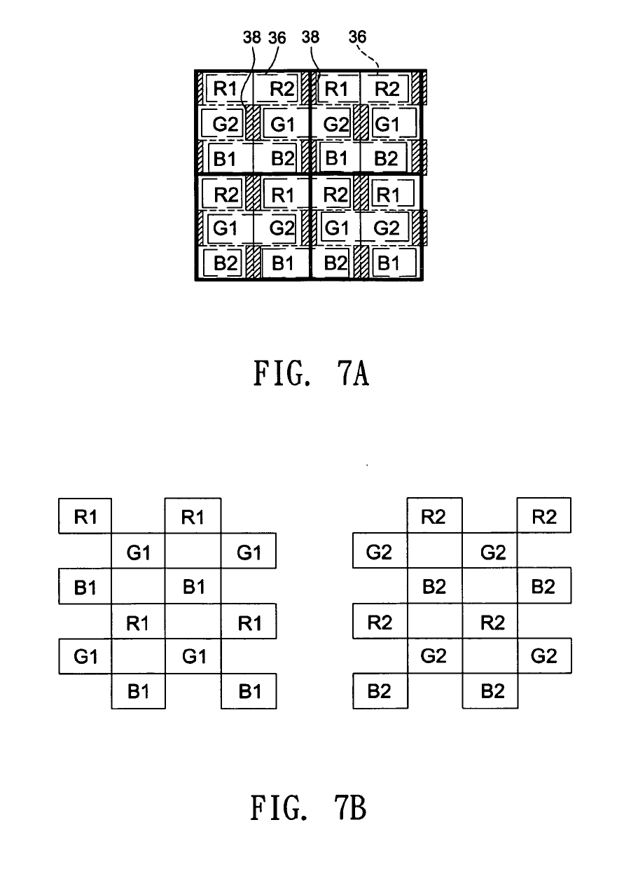

Alternatively, as shown in FIG. 7A, the first picture elements 32 (including sub-pixels R1, G1, and B1) and the second picture elements 34 (including sub-pixels R2, G2, and B2) are alternately arranged both in the horizontal and the vertical direction, and each bright region 36 or dark region 38 is staggered relative to each sub-pixel so as to form an arrangement of a checkerboard pattern on the self-luminous parallax optic 14. In that case, each eye of an observer can see either of the two complementary delta RGB sub-pixel arrangements, as shown in FIG. 7B. Thus, both red and green sub-pixels are available in each vertical and horizontal rows in a delta RGB sub-pixel arrangement to provide full color capability, and hence a sub-pixel rendering (SPR) technique can be performed in conjunction with the delta RGB sub-pixel arrangement to improve image quality.

While the invention has been described by way of examples and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An image display device capable of being switched between a two-dimensional (2D) display mode and a three-dimensional (3D) display mode, comprising:
a liquid crystal display panel having a plurality of first and second picture elements that are alternatively arranged for representing left-eye and right-eye image data, respectively; and
a self-luminous parallax optic having a first mode of forming alternate bright and dark regions and a second mode of forming an entire bright region thereon, wherein the alternate bright and dark regions are staggered relative to the first and second picture elements to create stereoscopy effect.

2. The image display device as claimed in claim 1, wherein the self-luminous parallax optic is an organic light-emitting diode (OLED) display, a plasma display panel (PDP), a field emission display (FED), or a vacuum fluorescent display (VFD).

3. The image display device as claimed in claim 1, wherein the self-luminous parallax optic is attached on one side of the liquid crystal display panel.

4. The image display device as claimed in claim 1, further comprising a transparent insulation layer provided between liquid crystal display panel and the self-luminous parallax optic.

5. The image display device as claimed in claim 4, wherein the transparent insulation layer is a passivation layer that covers all the bright and dark regions under the first mode.

6. The image display device as claimed in claim 1, wherein the first and second picture elements are arranged into multiple first and second rows, respectively, and each first and second row are alternate with each other.

7. The image display device as claimed in claim 6, wherein the bright and dark regions are formed as alternate bright and dark stripes that are staggered relative to the first and second rows.

8. The image display device as claimed in claim 1, wherein the first and second picture elements are alternatively arranged both in the horizontal direction and in the vertical direction.

9. The image display device as claimed in claim 8, wherein each bright or dark region is staggered relative to each picture element to form an arrangement of a checkerboard pattern.

10. An image display device capable of being switched between a 2D display mode and a 3D display mode, comprising:
a liquid crystal display panel;
a substrate positioned at one side of the liquid crystal display panel with a gap therebetween; and
a light-emitting structure provided on the surface of the liquid crystal display panel within the gap, wherein the light-emitting structure has a first mode of forming alternate bright and dark regions and a second mode of forming an entire bright region thereon.

11. The image display device as claimed in claim 10, wherein the light-emitting structure is formed in an organic light-emitting diode (OLED) display, a plasma display panel (PDP), a field emission display (FED), or a vacuum fluorescent display (VFD).

12. The image display device as claimed in claim 10, wherein the substrate is an encapsulating substrate, and the light-emitting structure is encapsulated between the encapsulating substrate and the liquid crystal display panel.

13. The image display device as claimed in claim 10, wherein the liquid crystal display panel has a plurality of first and second picture elements that are alternatively arranged for respectively representing left-eye and right-eye image data.

14. The image display device as claimed in claim 13, where the fist and second picture elements are respectively arranged into multiple first and second rows, and the bright and dark regions are formed as alternate bright and dark stripes that are staggered relative to the first and second rows.

15. The image display device as claimed in claim 13, wherein the first and second picture elements are alternatively arranged both in the horizontal direction and in the vertical direction, and each bright or dark region is staggered relative to each picture element to form an arrangement of a checkerboard pattern.

16. An image display device capable of being switched between a 2D display mode and a 3D display mode, comprising:
a liquid crystal display panel;
a substrate; and
a light-emitting structure formed on the substrate and interposed between the liquid crystal display panel and the substrate, wherein the light-emitting structure has a first mode of forming alternate bright and dark regions and a second mode of forming an entire bright region thereon.

17. The image display device as claimed in claim 16, further comprising a passivation layer provided between the light-emitting structure and the liquid crystal display panel.

18. The image display device as claimed in claim 16, wherein the light-emitting structure is formed in an organic light-emitting diode (OLED) display, a plasma display panel (PDP), a field emission display (FED), or a vacuum fluorescent display (VFD).

19. The image display device as claimed in claim 16, wherein the liquid crystal display panel has a plurality of first and second picture elements that are alternatively arranged for respectively representing left-eye and right-eye image data.

20. The image display device as claimed in claim 19, wherein the fist and second picture elements are respectively arranged into multiple first and second rows, and the bright and dark regions are formed as alternate bright and dark stripes that are staggered relative to the first and second rows.

21. The image display device as claimed in claim 19, wherein the first and second picture elements are alternatively arranged both in the horizontal direction and in the vertical direction, and each bright or dark region is staggered relative to each picture element to form an arrangement of a checkerboard pattern.
